(19) United States
(12) Patent Application Publication
(10) Pub. No.: US 2012/0134072 A1
(43) Pub. Date: May 31, 2012

(54) Electrodes having multi layered structure and supercapacitor including the same

(75) Inventors: Jun Hee Bae, Seoul (KR); Bae Kyun Kim, Seongnam-si (KR); Hak Kwan Kim, Hanam-si (KR)

(73) Assignee: SAMSUNG ELECTRO-MECHANICS CO., LTD, Suwon (KR)

(21) Appl. No.: 13/137,863

(22) Filed: Sep. 19, 2011

(30) Foreign Application Priority Data
Nov. 25, 2010 (KR) 10-2010-0118150

(51) Int. Cl. H01G 9/155; H01B 5/00

(52) U.S. Cl. 361/502; 174/126.2

(57) ABSTRACT

Disclosed herein are electrodes having a multi-layered structure, including at least two active material layers formed on an electrode current collector or including at least two active material layers formed on an electrode current collector, wherein at least two active material layers are stacked thereon, and a supercapacitor comprising the same. The electrodes including at least two active material layers configured of the activated carbon layer having large specific surface area and the graphene layer having excellent electrical conductivity in order to reduce the internal resistance and stacked in a multi layered structure are manufactured and the supercapacitor includes the electrodes to increase capacitance due to the large specific surface area of the activated carbon and reduce the internal resistance due to excellent electrical conductivity of the graphene, thereby making it possible to improve the capacitance and electrical conductivity.

### CROSS REFERENCE(S) TO RELATED APPLICATIONS

This application claims the benefit under 35 U.S.C. Section [120, 119, 119(e)] of Korean Patent Application Serial No. 10-2010-0118150, entitled “Electrodes Having Multi Layered Structure and Supercapacitor Including the Same” filed on Nov. 25, 2010, which is hereby incorporated by reference in its entirety into this application.

### BACKGROUND OF THE INVENTION

1. Technical Field

The present invention relates to electrodes having a multi layered structure and a supercapacitor comprising the same, and more particularly, to electrodes having a multi layered structure using an active material having high electrical characteristics, and a supercapacitor having improved output characteristics using the same.

2. Description of the Related Art

A supercapacitor, which is a product that is intensively improved in performance of capacitance among performances of a capacitor, serves as a battery. Accordingly, the supercapacitor, which is a capacitor having very large capacitance, is called an ‘ultracapacitor’ or an ‘ultrahigh-capacitance capacitor’. As a technical term, the supercapacitor is called an electrochemical capacitor in order to be distinguished from an existing electrostatic or electrolytic capacitor.

The supercapacitor may be divided into an electric double layer capacitor accumulating electricity through electrostatic absorption and desorption of ions, a pseudocapacitor accumulating electricity through oxidation-reduction reaction, and a hybrid capacitor having an asymmetric electrode form.

A battery, which is the most general energy storage, may store significant amounts of energy, while having a relatively small volume and weight, and generate appropriate output in various purposes to be used for various purposes.

However, the batteries have common problems such as low storage characteristics and a short life span regardless of the kinds thereof. This is due to natural deterioration or deterioration according to the use of chemical materials contained in the battery. Since there is no particular alternative to the battery, the battery cannot but be used, even with the disadvantages.

On the other hand, the supercapacitor uses a charging phenomenon by simple movement of ions to the interface of an electrode and an electrolyte or surface chemical reaction unlike the battery using chemical reaction. Accordingly, the supercapacitor has been spotlighted as the next generation storage capable of being used as an auxiliary battery or a product substituting for the battery due to characteristics such as rapid charging and discharging, high charging and discharging efficiency and semi-permanent cycle life span.

FIG. 1 shows a structure of a general supercapacitor. Referring to FIG. 1, a positive electrode 10 and a negative electrode 20 manufactured by applying each of the electrode active materials 12 and 22 on each of the electrode current collectors 11 and 21 are coupled to each other, having a separator 30 therebetween. The capacitor configured of the positive electrode, the separator, and the negative electrode is received in various gaskets 40 and then an electrolyte 50 is injected thereinto, thereby manufacturing a final capacitor.

Electricity is charged in the supercapacitor having the configuration according to the related art by an electrochemical principle in which several volts of voltage is applied to the current collectors 11 and 12 connected to both ends of the electrode, an electric field is formed so that ions move within an electrolyte to be absorbed into a surface of the electrode, and as a result, the electricity is stored.

Various active materials have actually been used in manufacturing the electrode of the supercapacitor. As the most general material, activated carbon is mainly used. In addition to the activated carbon, carbon aerogel and various carbon-based materials have been used.

The activated carbon has high specific surface area; however, has relatively low electrical conductivity. Due to the disadvantage, the activated carbon has many limitations in being used in a heavy equipment field and an electric vehicle field requiring high output.

### SUMMARY OF THE INVENTION

An object of the present invention is to provide electrodes having a multi layered structure of a supercapacitor which has high capacitance and electrical conductivity to reduce internal resistance.

Another object of the present invention is to provide a supercapacitor which includes the electrodes having a multi layered structure to improve capacitance and electrical conductivity.

According to an exemplary embodiment of the present invention, there are provided electrodes having a multi-layered structure, including at least two active material layers formed on an electrode current collector.

According to another exemplary embodiment of the present invention, there are provided electrodes having a multi-layered structure, including at least two active material layers formed on an electrode current collector, wherein the at least two active material layers are stacked thereon.

The at least two active material layers may be an activated carbon layer and a graphene layer.

The active material layer may be formed by sequentially stacking the graphene layer and the activated carbon layer on the electrode current collector.

A total thickness of the activated carbon layer may be 80 to 150 μm.

A total thickness of the graphene layer may be 1 to 15 μm.

According to another exemplary embodiment of the present invention, there is provided a supercapacitor, including electrodes having a multi layered structure including at least two active material layers formed on an electrode current collector.

According to another exemplary embodiment of the present invention, there is provided a supercapacitor, including electrodes having a multi layered structure including at least two active material layers formed on an electrode current collector, wherein the at least two active material layers are stacked thereon.

### BRIEF DESCRIPTION OF THE DRAWINGS

FIG. 1 is a view showing a configuration of a general supercapacitor;

FIGS. 2 and 3 are views of a configuration of an electrode according to an exemplary embodiment of the present invention;

FIG. 4 is a view showing measurement results of resistance (ESR) of Example 1 and Comparative Example 1;

FIG. 5 is a view showing measurement results of peel strength of Example 1 and Comparative Example 1; and

FIG. 6 is a view showing measurement results of the capacitance of Example 1 and Comparative Example 1.

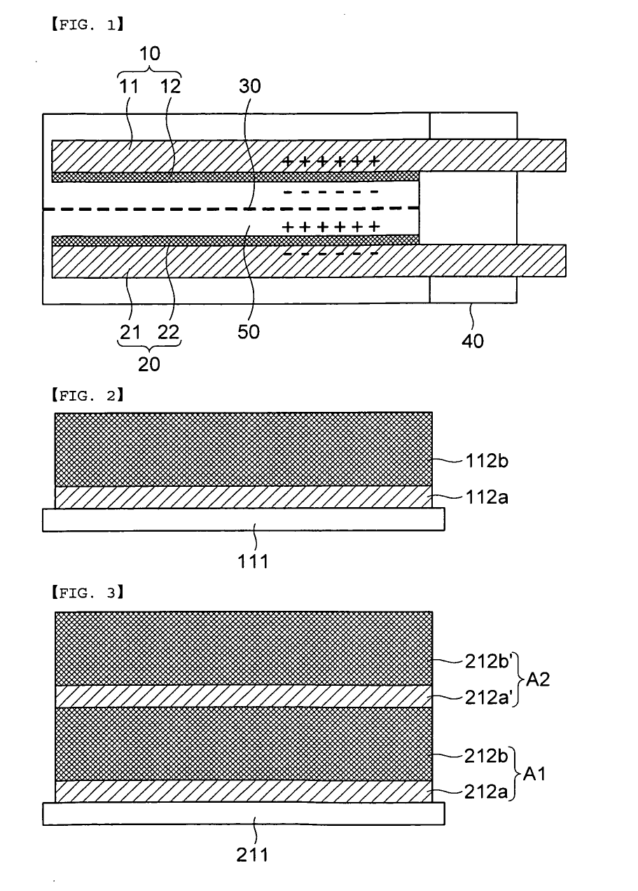

### DESCRIPTION OF THE PREFERRED EMBODIMENTS

Hereinafter, preferred embodiments of the present invention will be described in detail with reference to the accompanying drawings.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated shapes, numerals, steps, operations, members, elements and/or a group thereof but not exclusion of existence or addition of any other shapes, numerals, steps, operations, members, elements and/or a group thereof.

In addition, a thickness or a size of each layer will be exaggerated for convenience of explanation or clarity and like reference numbers will indicate the same elements, in the drawings below. As used in the present specification, a term “and/or” includes any one or at least one combination of enumerated items.

In the present specification, although terms such as first, second, etc., are used to explain various members, components, areas, layers and/or portions thereof, these members, components, areas, layers and/or portions thereof are not limited to these terms. These terms are used only to distinguish one member, component, area, layer or a portion thereof from another member, component, area, layer or a portion thereof. Accordingly, a first member, a first component, a first area, a first layer, or a portion thereof described below may indicate a second member, a second component, a second area, a second layer, or a portion thereof.

The present invention relates to electrodes having a multi layered structure including at least two active material layers and a super capacitor comprising the same.

Activated carbon most used as an electrode active material of a supercapacitor has specific surface area of 1500 to 2000 m²/g or more; however, has non-uniform pores thereof to cause unsmooth penetration of ions, thereby lowering electrical conductivity.

Accordingly, the present invention changes a structure of the electrodes so as to include active material layers having a multi layered structure including a first active material layer made of the activated carbon used in the related art and a second active material layer made of graphene having more excellent electrical characteristics than a CNT in order to supplement a disadvantage of the activated carbon.

Theoretically, it may be most ideal when the activated carbon and the graphene are mixed to form one active material layer. However, when the activated carbon and the graphene are mixed to form slurry, the activated carbon and the graphene are not well mixed, thereby causing a phase separation phenomenon. Accordingly, the present invention solves the problem by independently configuring the activated carbon layer and the graphene layer.

An electrode according to an exemplary embodiment of the present invention has a multi layered structure including at least two active material layers 112a and 112b on an electrode current collector 111, as shown in FIG. 2.

According to an exemplary embodiment of the present invention, each of the at least two active material layers may be an activated carbon layer and a graphene layer.

The activated carbon included in the active material layer may be produced by activating a carbonaceous material. As a method for activating the carbonaceous material, any known methods may be used. For example, the carbonaceous material may be activated by a chemical activation method using a chemical material capable of being oxidized, e.g., zinc chloride, phosphoric acid, sulfuric acid, calcium chloride, sodium hydroxide, potassium bichromate, potassium permanganate, and the like; or a gas activation method using steam, propane gas, exhaust gas generated from combustion gas, which is a mixture of CO₂ and H₂O, carbon dioxide gas, and the like.

In addition, the graphene included in the active material layer according to an exemplary embodiment of the present invention is a material having physical strength 200 times or more excellent than that of steel and having thermal conductivity of about 500 W/mK at a room temperature. This thermal conductivity is 50% or more higher than that of a carbon nano tube, and is ten times larger than that of metal such as copper or aluminum.

In addition, the graphene has rapid electron mobility and long mean free path of electron at a normal temperature. This is the reason that the degree of scattering disturbing movement of electrons is very small. Accordingly, the graphene has a resistance value of 35% or more lower than that of copper having very low resistance.

Further, it has very flexible characteristics due to a very thin thickness. Although an area of the graphene is increased or folded by 10% or more, the graphene does not lose electrical conductivity. Accordingly, due to this flexibility, the graphene may be bent, thereby making it possible to manufacture a ball-shaped material such as fullerene, a carbon nano tube, or the like, and be also used as a transparent electrode of a flexible display.

Therefore, the present invention includes the graphene having these various characteristics, in particular, excellent electrical characteristics as the active material layer to supplement a disadvantage of the activated carbon.

The electrode according to an exemplary embodiment of the present invention may be manufactured by forming the graphene layer 112a, which is a first active material layer, on the electrode current collector 111 and then forming the activated carbon layer 112b, which is a second active material layer, on the graphene layer 112a, as shown in FIG. 2.

In addition, according to another exemplary embodiment of the present invention, an electrode may include at least two active material layers on the electrode current collector and have a multi layered structure in which the at least two active material layers are stacked.

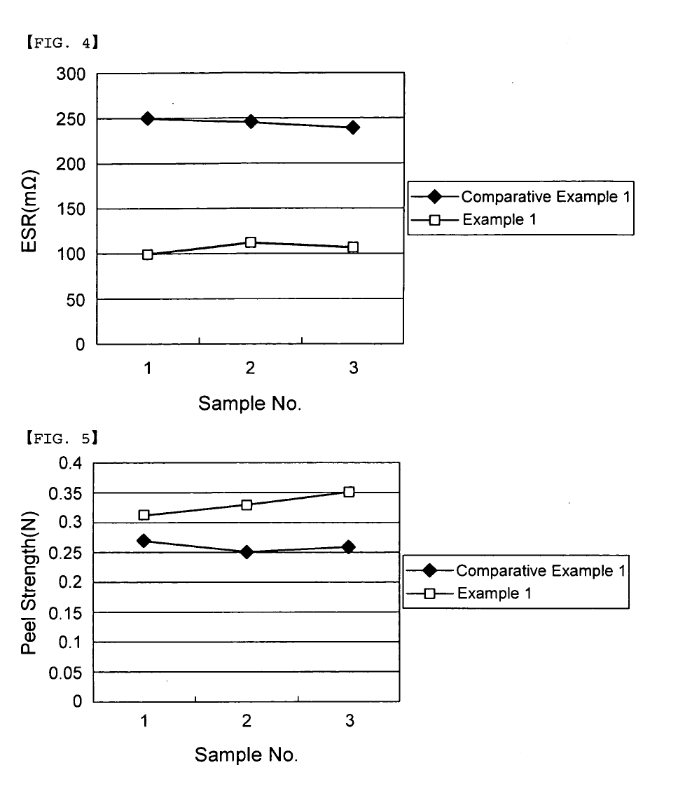

Next, described in detail with reference to FIG. 3, a graphene layer 212a, which is a first active material layer, is first formed on an electrode current collector 211, and an activated carbon layer 212b, which is a second active layer, is formed on the graphene layer 212a. Then, the graphene layer 212a and the activated carbon layer 212b are used as one unit active material layer (A1), and a graphene layer 212a′ and an activated carbon layer 212b′ are stacked again on the unit active material layer (A1) to be used as another active material layer (A2), thereby making it possible to form an electrode.

The stack number of the unit active material layers configured of the graphene layer and the activated carbon layer is not specially limited. The unit active material layers may be used by being appropriately stacked at a desired thickness.

The present invention may preferably have a structure in which the graphene layer is formed on the electrode current collector and then the activated carbon layer is stacked on the graphene layer in the case in which the graphene layer and the activated carbon layer form the electrode in a multi layered structure having at least two layers. That is, the graphene layer may be preferably formed on a surface contacting the electrode current collector because it may increase electrical conductivity from the activated carbon layer to the electrode current collector.

This structure is also equally applied in the case in which the unit active material layer configured of the graphene layer and the activated carbon layer is stacked.

A total thickness of the activated carbon layer formed in the electrode may preferably be 80 to 150 μm. When the thickness of the activated carbon layer is below 80 μm, capacitance deterioration occurs, and when the thickness thereof is over 150 μm, a crack, etc., occurs to cause an electrode defect.

In addition, a total thickness of the graphene layer formed in the electrode may preferably be 1 to 15 μm. When the thickness of the graphene layer is below 1 μm, an adhesive between the current collector and the electrode is deteriorated and when the thickness of the graphene layer is over 15 μm, the thickness of the activated carbon layer is lowered to cause capacitance deterioration.

Each thickness of the activated carbon layer and the graphene layer means the total thickness of each of the activated carbon layers and the graphene layers capable of being formed in the electrode. The activated carbon layer and the graphene layer may be formed as various layers within the thickness range.

The electrode in which the activated carbon active material layer having large specific surface area and the graphene active material layer having excellent electrical conductivity to reduce internal resistance are formed in the multi layered structure increases capacitance due to the high specific surface area of the activated carbon and reduces the internal resistance due to the excellent electrical conductivity of the graphene, thereby making it possible to improve the capacitance and the electrical conductivity. The structure of the electrode may be a structure capable of improving output characteristics of a supercapacitor through the reduction of the internal resistance, while having a predetermined specific surface area.

In addition, the present invention forms the multi layered structure by forming the graphene layer having the excellent electrical conductivity on the electrode current collector and then forming the activated carbon on the graphene layer, thereby making it possible to solve a problem that the graphene and the activated carbon are not well mixed.

When the active material layer is applied so as to form the electrode according to an exemplary embodiment of the present invention, a binder, a conductive material, a solvent, etc., as well as the active material such as the activated carbon and the graphene are added to the active material layer to be produced in a slurry state and the slurry is applied to the electrode current collector, thereby manufacturing the electrode.

The activated carbon, which is the active material included in the mixed slurry for forming the activated carbon layer, may preferably be mixed at a maximum 80 wt % with respect to the total slurry composition in terms of capacitance of the electrode and stability of the electrode quality.

In addition, the graphene, which is the active material included in the mixed slurry for forming the graphene layer, may preferably be mixed at a maximum 10 wt % with respect to the total slurry composition in terms of reduction in internal resistance and stability of electrode quality.

As specific examples of the conductive material, granular acetylene black, super P black, carbon black, hard carbon, soft carbon, graphite, metal powders (Al, Pt, Ni, Cu, Au, stainless steel, or a alloy thereof), and one selected from a group consisting of powders formed by coating the above-mentioned metal to carbon black, active carbon, hard carbon, soft carbon, and graphite by electroless plating, or two or more mixture thereof may be used.

As the binder, CMC (carboxy methyl cellulose), SBR (styrene butadiene rubber), and the like, may be used, without being particularly limited thereto.

As the solvent, water, alcohol, and the like, may be used, without being particularly limited thereto. As the alcohol, isopropyl alcohol, ethanol, butanol, phentanol, heptanol, propanol, hexanol, and the like, may be used. The content of the solvent may preferably be 50 to 60 wt % with respect to the total content of the electrode slurry mixture.

According to an exemplary embodiment of the present invention, the electrode is used in a supercapacitor. When the supercapacitor is an electric double layer capacitor, both of a positive electrode and a negative electrode may have the electrode structure as described above. In addition, when the supercapacitor is a lithium ion capacitor, the electrode may be used in a positive electrode.

Meanwhile, the present invention provides a supercapacitor including the electrode.

The supercapacitor includes a positive electrode having a structure in which a graphene layer and an activated carbon layer are sequentially stacked on a positive electrode current collector; a negative electrode in which a negative active material layer is formed on a negative electrode current collector; and a separator disposed therebetween, and has a structure in which the capacitor configured of the positive electrode, the separator, and the negative electrode is received in various gaskets and then an electrolyte solution is injected thereinto.

As each of the electrode current collectors on which the active material layers are formed, several materials including metal that does not cause dissolution and precipitation in a use voltage range and has high conductivity, for example, metal such as aluminum, titanium, nickel, stainless steel, etc., and non-metal such as a conductive polymer film, a conductive filler containing plastic film, etc., may be used. Although inexpensive aluminum capable of suppressing increase in resistance during use may be manufactured in a plate shape or a thin shape to be used as the electrode current collector, the present invention is not limited thereto.

When the supercapacitor according to an exemplary embodiment of the present invention is the electric double layer capacitor, the positive and negative electrodes used as the electrode may use the multi layered structure configured of the activated carbon layer and the graphene layer as described above.

In addition, when the supercapacitor according to an exemplary embodiment of the present invention is the lithium ion capacitor, the positive electrode used as the electrode may use the multi layered structure configured of the activated carbon layer and the graphene layer and the negative electrode may have the active material layer formed using a porous carbonaceous material.

The carbonaceous material used as the active material layer of the negative electrode is not particularly limited but may be any material capable of being activated into the activated carbon. As materials capable of being activated into the activated carbon, there are a carbonaceous coconut shell, a petroleum pitch and/or a coal pitch, a coke, a phenol-based resin, polyvinyl chloride, etc., by way of example. The shape of the carbonaceous material is not particularly limited but may include, for example, a granular shape, a pulverulent shape, a fibrous shape, a sheet shape, etc.

As examples of the fibrous shape or the sheet shape, there are natural cellulose fiber, for example, cotton, and the like; regenerated cellulose fiber, for example, viscose rayon, polynosic rayon, and the like; pulp fiber; synthetic fiber, for example, polyvinyl alcohol fiber, polyethylene-vinyl alcohol fiber, and the like; and woven, nonwoven, film, felt and sheet thereof.

In addition, the separator according to an exemplary embodiment of the present invention serves to block internal short circuit of the negative and positive electrodes and impregnate electrolyte solution. As the materials for the separator capable of being used in the supercapacitor according to an exemplary embodiment of the present invention, there are polyethylene nonwoven, polypropylene nonwoven, polyester nonwoven, polyacrylonitrile porous separator, poly (vinylidene fluoride) hexafluoropropane copolymer porous separator, cellulose porous separator, kraft paper or rayon fabric, and the like. In addition, the materials of the separator capable of being used in the supercapacitor according to an exemplary embodiment of the present invention are not particularly limited, if they are materials generally used in the fields of a battery and a capacitor.

Further, as the material of the gasket, for example, a resin such as ABS, butyl rubber, polyolefin-based resin, and the like, and most preferably, colorless and transparent polyolefin-based resin may be used. The polyolefin-based resin may satisfy all requirements required by the gasket in terms of chemical characteristics, thermal characteristics, and mechanical strength and may see with the naked eyes that the electrolyte solution is leaked during a manufacturing process because it is colorless and transparent.

As an electrolyte charged in the supercapacitor according to an exemplary embodiment of the present invention, aqueous electrolyte, non-aqueous electrolyte, solid electrolyte, or the like, may be used.

As the aqueous electrolyte, 5 to 100 wt % of sulfuric acid aqueous solution, 0.5 to 20 mole concentration of potassium hydroxide aqueous solution, or 0.2 to 10 mole concentration of potassium chloride aqueous solution, sodium chloride aqueous solution, potassium nitrate aqueous solution, sodium nitrate aqueous solution, potassium sulfate aqueous solution, sodium sulfate aqueous solution, and the like, which are neutral electrolytes, may be used, without being particularly limited thereto.

As the non-aqueous electrolyte, organic electrolyte, etc., produced by dissolving 0.5 to 3 mole concentration of salt made of cations such as tetraalkylamonium (for example, tetraethylamonium or tetramethylamonium), lithium ion, potassium ion, or the like, and anions such as tetrafluoroborate, perchlorate, hexafluorophospate, bistrifluoromethanesulfonylimide, trisfluoromethanesulfonylmethide, or the like, in a non-protonic solvent, particularly, a solvent having a high dielectric constant (for example, propylene carbonate or ethylene carbonate) or a solvent having low viscosity (diethylcarbonate, dimethylcarbonate, ethylmethylcarbonate, dimethylether or diethylether) may be used, without being particularly limited thereto.

In addition, as the electrolyte, a gel polymer electrolyte produced by impregnating the polymer electrolyte such as polyethyleneoxide, polycarbonate, polyacrylonitrile, and the like, with the electrolyte solution or an inorganic solid electrolyte such as LiI, Li₃N, and the like, may be used.

Hereinafter, the present invention will be described in detail with reference to Examples. Examples of the present invention are provided in order to more completely explain the present invention to those skilled in the art. Examples below may be modified in several different forms and does not limit a scope of the present invention. Rather, these Examples are provided in order to make this disclosure more thorough and complete and completely transfer ideas of the present invention to those skilled in the art.

### EXAMPLE 1

A graphene layer having a thickness of 3 μm was formed on an aluminum foil, which is a current collector.

Then, 80 g of activated carbon as an active material, log of carbon black as a conductive material, and 7 g of CMC (carboxy methyl cellulose) and 3 g of SBR(styrene butadiene rubber) as a binder were mixed and agitated in 150 g of water, which is a solvent, to produce mixed slurry, and an activated carbon layer having a thickness of 20 μm was formed on the graphene layer using the slurry.

Electrodes of a supercapacitor were obtained using five graphene layers and five activated carbon layers through the above-mentioned method. The electrodes were dried and roll-pressed, were cut according to a desired electrode shape, and then were vacuum dried to manufacture electrodes for a supercapacitor.

The manufactured electrodes were separated from each other using a cellulose separator and a polycarbonate electrolyte was added thereto to manufacture a pouch type of electric double layer supercapacitor.

### COMPARATIVE EXAMPLE 1

An electric double layer supercapacitor was manufactured using the same method as that of Example 1, except that 80 g of activated carbon as an active material, log of carbon black as a conductive material, and 7 g of CMC and 3 g of SBR as a binder were mixed and agitated in 150 g of water, which is a solvent, to produce mixed slurry, and electrodes including only an activated carbon layer having a thickness of 115 μm as an active material layer on aluminum foil, which is a current collector, were manufactured.

### EXPERIMENTAL EXAMPLE

Physical properties were measured using the supercapacitor manufactured according to the Example and the Comparative Example as follows. The results thereof were shown in FIGS. 4 to 6. Each of the physical properties was measured using three kinds of samples.

ESR (Equivalent Series Resistance): DC ESR was measured using a single cell EDLC of 3×4 cm.

Capacitance: it was measured using a single cell EDLC of 3×4 cm.

Peel strength: it was measured at a speed of 300 mm/min using an IMADA peeling test (180° peel test). (Model Name: IPT200-5N)

FIG. 4 is a view showing measurement results of the ESR of the Example 1 and the Comparative Example 1. Referring to FIG. 4, it could be appreciated that the supercapacitor including the active material layers having the multi layered structure configured of the graphene layer and the activated carbon layer according to the exemplary embodiment of the present invention has a much lower resistance value, as compared to the supercapacitor including the active material layer of a positive electrode having a single layer structure configured of the activated carbon layer according to the Comparative Example. It could be appreciated that this property is a result obtained by adding the graphene layer having high electrical conductivity to the electrode having the single layer structure configured of the activated carbon layer according to the related art to form the multi layered structure.

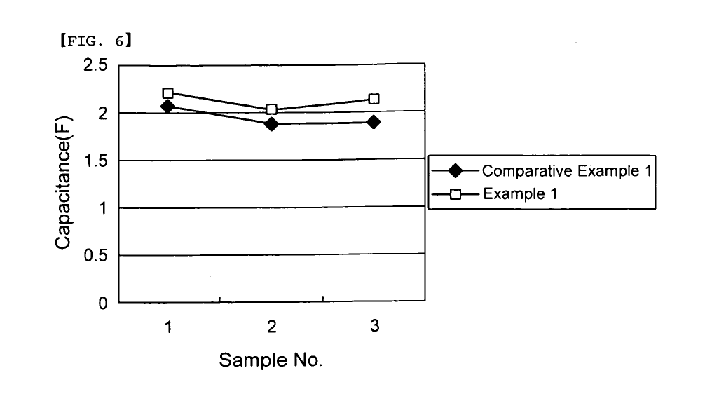

In addition, FIG. 5 is a view showing measurement results of peel strength of the Example 1 and the Comparative Example 1. Referring to FIG. 5, it was appreciated that the peel strength of the capacitor of the Example 1 having the electrode structure according to the exemplary embodiment of the present invention is more excellent than that of the Comparative Example 1. That is, it means that although the multi layered structure configured of the activated carbon layer and the graphene layer is applied to the electrode current collector in the present invention, the active material layer is stably attached onto the electrode current collector during use. Accordingly, it could be expected through the peel strength that although the supercapacitor according to the exemplary embodiment of the present invention is used for a long period, it may secure reliability.

In addition, FIG. 6 is a view showing measurement results of capacitance of the Example 1 and the Comparative Example 1. Referring to FIG. 6, it was observed that the present invention adds the graphene layer together with the activated carbon layer to form the electrode, such that capacitance thereof is increased as compared to that of the Comparative Example 1 according to the related art, which includes only the activated carbon layer. That is, it was appreciated that the present invention adds the graphene layer having excellent electrical conductivity to supplement a problem that the activated carbon has low conductivity, while lowering the internal resistance, thereby increasing the capacitance of the capacitor.

According to the exemplary embodiments of the present invention, the electrodes including at least two active material layers configured of the activated carbon layer having large specific surface area and the graphene layer having excellent electrical conductivity to reduce the internal resistance and stacked in a multi layered structure are manufactured and the supercapacitor includes the electrodes to increase capacitance due to the large specific surface area of the activated carbon and reduce the internal resistance due to the excellent electrical conductivity of the graphene, thereby making it possible to improve the capacitance and the electrical conductivity.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. Electrodes having a multi-layered structure, comprising at least two active material layers formed on an electrode current collector.

2. Electrodes having a multi-layered structure, comprising at least two active material layers formed on an electrode current collector, wherein the at least two active material layers are stacked thereon.

3. The electrodes having a multi-layered structure according to claim 1, wherein the at least two active material layers are an activated carbon layer and a graphene layer.

4. The electrodes having a multi-layered structure according to claim 2, wherein the at least two active material layers are an activated carbon layer and a graphene layer.

5. The electrodes having a multi-layered structure according to claim 3, wherein the active material layer is formed by sequentially stacking the graphene layer and the activated carbon layer on the electrode current collector.

6. The electrodes having a multi-layered structure according to claim 4, wherein the active material layer is formed by sequentially stacking the graphene layer and the activated carbon layer on the electrode current collector.

7. The electrodes having a multi-layered structure according to claim 3, wherein a total thickness of the activated carbon layer is 80 to 150 μm.

8. The electrodes having a multi-layered structure according to claim 4, wherein a total thickness of the activated carbon layer is 80 to 150 μm.

9. The electrodes having a multi-layered structure according to claim 3, wherein a total thickness of the graphene layer is 1 to 15 μm.

10. The electrodes having a multi-layered structure according to claim 4, wherein a total thickness of the graphene layer is 1 to 15 μm.

11. A supercapacitor comprising the electrodes having a multi-layered structure according to claim 1.

12. A supercapacitor comprising the electrodes having a multi-layered structure according to claim 2.
